(19) United States
(12) Patent Application Publication
(10) Pub. No.: US 2016/0347016 A1
(43) Pub. Date: Dec. 1, 2016

(54) DEVICE FOR COMPACTING PULP FLOCKS

(71) Applicant: ANDRITZ AG, Graz (AT)

(72) Inventor: Hubert Riemer, St. Oswald (AT)

(21) Appl. No.: 15/166,992

(22) Filed: May 27, 2016

(30) Foreign Application Priority Data
May 29, 2015 (AT) A 50438/2015

(51) Int. Cl. B30B 9/30; B30B 1/14; B30B 15/00; D21D 99/00

(52) U.S. Cl. CPC B30B 9/301; D21D 99/00; B30B 1/14; B30B 15/0029

(57) ABSTRACT

A device for compacting pulp flocks into slabs or preferably prism-shaped bale in a press with a device for feeding the pulp to the press with a least one buffer chute. The press unit is provided in the form of a mechanical toggle press and at least one pre-compaction unit. This can replace the commonly-used hydraulic system and greatly reduces the amount of maintenance required. In addition, it can shorten the cycle time and thus increase production.

### BACKGROUND

The present invention relates to a device for compacting pulp flocks into slabs or a preferably prism-shaped bale in a press with a device for feeding the pulp to the press with a least one buffer chute.

In the pulp and paper industry, so-called slab presses are normally used after a flash dryer for fluff pulp or mechanical pulp to compact the pulp flocks into slabs, where several slabs are combined to form a bale and then further compacted. Slab presses of this type are known from AT 502387. Here, the pulp flocks are divided into two flows after being pre-compacted and then pushed into the press chute from two sides. The necessary pressing force is applied there by means of a strong hydraulic cylinder. The disadvantages of the known systems are that the cycle times are limited due to the required transport of the hydraulic oil, that a large amount of hydraulic oil is needed, and that there is a risk of contamination if there are any leaks. In addition, eccentric presses are known from U.S. Pat. No. 1,332,576, for example, in which the levers have a point of passage when extended, where neither the applied force nor the height of the finished product can be set because they are defined by the design of the press.

### SUMMARY

The object of the invention is to avoid the maintenance times and risk of contamination as far as possible.

The invention is disclosed as a press unit in the form of a mechanical toggle press with at least one pre-compaction unit. As a result, it is possible to achieve shorter cycle times, and thus increased production, as well as high pressing forces in a favourable way. An advantageous embodiment of the invention is characterized in that the press unit is designed as a purely electro-mechanical system driven by a servomotor and gearbox. This can replace the hydraulic system and greatly reduces the amount of maintenance required.

A favorable embodiment of the invention is characterized in that the lengths of the levers in the toggle press can be adapted, where the eccentric of the toggle press can also be suitable for adaptation. With these design features, the force, speed, and acceleration progressions at the press ram can be adapted to the compression speed and the compression resistance during bale compacting to optimum effect.

It has also proved to be an advantage if a device for stroke adjustment is provided between the toggle press and the press ram. By adjusting the stroke, the maximum pressing force can always be applied in the final position of the toggle levers even if the individual slabs are different heights.

An advantageous embodiment of the invention is characterized in that a motor is provided to apply force, where it would also be possible as an alternative to provide a motor on either side or a toothed rod with a drive.

### BRIEF DESCRIPTION OF THE DRAWING

The invention will now be disclosed in examples and referring to the drawing, where:

FIG. 1 shows a sectional view of the press according to the invention,

FIG. 2 shows a side view of the press according to FIG. 1, and

FIG. 3 shows a sectional view along the line marked III-III in FIG. 1.

### DETAILED DESCRIPTION

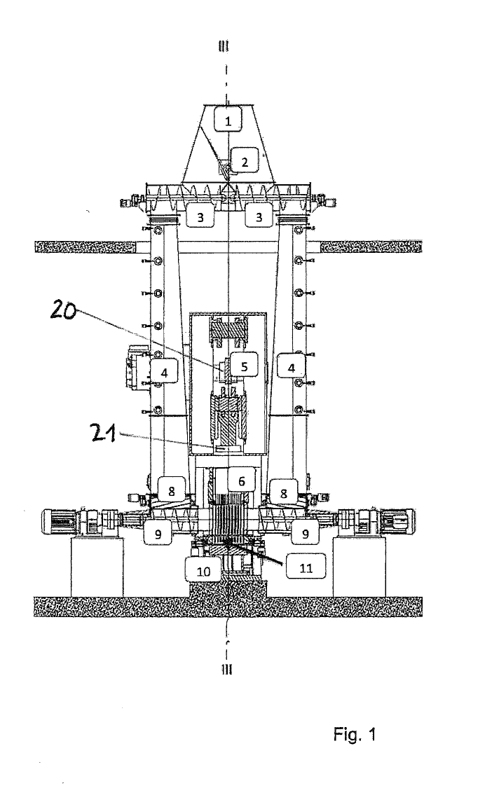

FIG. 1 shows a slab press according to the invention. A slab press is used to compact fluff pulp into preferably prism-shaped bales. Thus, a slab press normally produces single slabs, or a stack of slabs forming a bale. For this purpose, dried fluff pulp or mechanical pulp is fed to the distribution container 1 of the slab press after the drying plant. The pulp is divided between two buffer chutes 4 by means of a distribution flap 2 and distribution screws 3. Feed drums 8 and dosing screws 9 convey the pre-compressed pulp flocks into the press chute, where the fluff pulp is compressed to its final density in the press yoke 10 by means of the press ram 6.

The feed drums 8 supply the fluff pulp evenly to the dosing screw conveyors 9 as pre-compaction units. Due to the increasing pitch of the screw flights the pulp will be compacted. Alternative pre-compaction units such as gate valves can also be used. With a gate valve the pulp falls into a chamber of the valve and will be compressed by e.g. a hydraulic cylinder with a stamp.

The compacted pulp slab is pushed out of the press sideways through sliding moulds 11 and then vertically by bale ejectors 12. The pressing force is applied via a toggle press 5 driven by a servomotor and a gear box. The main advantages of the toggle press are that he levers, can be controlled in such a way that the exact pressing force needed or the exact bale height required is achieved. There is no need to extend the levers fully in order to do this. After reaching the maximum pressing force or the desired height, the levers return to their starting position again and thus relieve the pressure on the pulp bale produced. Unlike eccentric presses, which do not reach their maximum force until the lowest point when the levers are disposed in a straight line, it is possible to regulate the height of the bale easily at the toggle press, meaning that variable bale heights can also be produced or a product changeover can be implemented very easily.

Several level sensors mounted at different heights are located at the buffer chutes 4. The distribution flap is set accordingly in order to feed both chutes as evenly as possible with fluff pulp or mechanical pulp from the distribution screws. It is also possible to control the press via the rotation speed of the distribution screws. Due to the toggle press system, it is possible to achieve shorter cycle times and thus, higher output than with conventional hydraulic systems. In addition, the overall efficiency is greater and less maintenance is needed than with the systems used so far. The use of hydraulics can be avoided by using servo-drives in combination with the toggle principle.

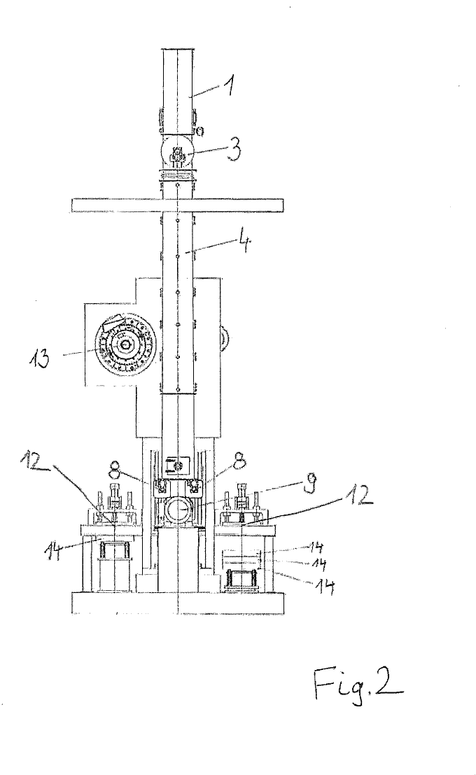

FIG. 2 shows a side view of the press according to the invention. This also shows a distribution tank 1, a distribution screw 3, and a buffer chute 4. In addition, it shows that two feed drums 8 each act on a dosing screw 9. The lower section shows the finished slabs 14, where there is one finished slab on one side and already three finished slabs 14 on the other side. The servo-drive 13 for the press unit is visible in the middle section. It is connected via a gearing to the lever 16 to allow the movement in direction of the arrow 18.

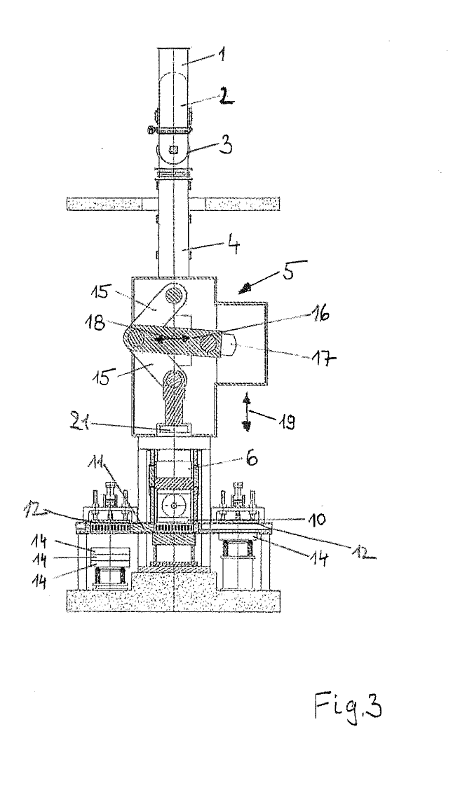

FIG. 3 shows a sectional view of the press along the line marked III-III in FIG. 1. The movable mould 11 is clearly visible here in the bottom part. It consists of two sections in which the slabs 14 are formed. One of these sections is disposed under the press ram 6 during a pressing cycle and the other is above the press yoke 10. When this section has been filled, the movable mould 11 is moved (to the right in the illustration) and the freshly pressed slab 14 is ejected. While this is taking place, the second section is filled. Then the mould 11 is moved (to the left in the illustration) and the slab 14 thus formed is ejected onto the other stack. As soon as there are three to five slabs 14, for example, on the stack, it is brought to a subsequent bale press. With this arrangement, the cycle times can be further reduced.

The press unit 5 consists of several levers 15 and 16, respectively. Due to the movement of the lever 16 along the slot 17 in the direction of the arrow 18, the other two levers are moved into a straight line above one another, which causes the press ram 6 to be moved in the direction of the arrow 19 and applies the maximum pressing force when the levers 15 are in the extended position. A stroke adjusting device 21 between the levers and the press ram 6 and which is built into the head of the press ram 6 will ensure that the maximum pressing force is applied to the pulp at all times, which is very important with different filling heights. More generally, “adjusting” should be understood as adapting to a desired size, such as length, by either physically altering the component, modifying an intermediate component, or replacing the component with one of a different size. In order to adapt the force progression, but also the speed and acceleration progressions to the compression resistance or adapt the compression speed to the pulp flocks to be pressed during the pressing cycle, the length of the levers 15, 16 can be selected accordingly. This can also be achieved by modifying the eccentric disc 20.

The invention is not limited to the examples shown. For example, the press can be driven by servomotors mounted on both sides or by a driven, toothed rod.

1. A device for compacting pulp flocks in a press, comprising:
a buffer chute for receiving the pulp flocks;
a pre-compaction unit for receiving the pulp flocks from the chute and feeding partially compacted pulp flocks to a pressing unit;
wherein said pressing unit includes a mechanical toggle for advancing a press ram against the partially compacted pulp flocks.

2. The device of claim 1, wherein the pressing unit is a purely electro-mechanical system in which the mechanical toggle is driven by a servo motor and gearbox.

3. The device of claim 1, in which the mechanical toggle includes a plurality of adjustable-length levers.

4. The device of claim 1, wherein the mechanical toggle includes an adjustable eccentric.

5. The device of claim 1, wherein the press ram has a pressing stroke and a stroke-adjustment device is provided between the mechanical toggle and the press ram.

6. The device of claim 2, wherein the mechanical toggle includes a plurality of adjustable-length levers.

7. The device of claim 2, wherein the mechanical toggle includes an adjustable eccentric.

8. The device of claim 2, wherein the press ram has a pressing stroke and a stroke-adjustment device is provided between the mechanical toggle and the press ram.

9. The device of claim 1, wherein the mechanical toggle includes an adjustable eccentric and the press ram has a pressing stroke and a stroke-adjustment device is provided between the mechanical toggle and the press ram.

10. The device of claim 3, wherein the press ram has a pressing stroke and a stroke-adjustment device is provided between the mechanical toggle and the press ram.

11. The device of claim 6, wherein the mechanical toggle includes an adjustable eccentric and the press ram has a pressing stroke and a stroke-adjustment device is provided between the mechanical toggle and the press ram.

12. The device of claim 1, wherein the pre-compaction device includes a dosing screw conveyor.

13. The device of claim 1, including
a pair of buffer chutes on opposite sides of said pressing unit;
a distribution device for alternating delivery of pulp flocks to one then the other of said buffer chutes; and
a respective pair of pre-compaction units operatively associated respectively with said buffer chutes and with said pressing unit, whereby pre-compacted pulp flock from one pre-compaction unit is supplied to the pressing unit in alternation with supply of pre-compacted pulp flock from the other pre-compaction unit.

14. The device of claim 12, wherein the pre-compaction device includes a dosing screw conveyor.

15. The device of claim 1, wherein the mechanical toggle has lateral sides and one motor applies force on one lateral side of the toggle or a motor on each lateral side applies force to the toggle.

16. The device of claim 1, wherein a toothed rod with an operatively connected drive applies force to the mechanical toggle.
